(19) United States
(12) Patent Application Publication
(10) Pub. No.: US 2009/0070263 A1
(43) Pub. Date: Mar. 12, 2009

(54) PEER TO PEER FUND TRANSFER

(75) Inventors: Martin Davis, Charlotte, NC (US); Mike Duke, Monroe, NC (US)

Correspondence Address: AMIN, TUROCY & CALVIN, LLP, 127 Public Square, 57th Floor, Key Tower, CLEVELAND, OH, 44114, US

(73) Assignee: WACHOVIA CORPORATION, Charlotte, NC (US)

(21) Appl. No.: 11/854,018

(22) Filed: Sep. 12, 2007

(51) Int. Cl. G06Q 40/00

(52) U.S. Cl. 705/44; 705/39

(57) ABSTRACT

Systems and methods that facilitate using a first mobile device to initiate a funds transfer to a second device. One mobile to consumer payment embodiment allows a person enter into a store and pay for that person's purchases using that person's cell phone. Other mobile consumer payment embodiments include strictly consumer-to-consumer transactions, for example, but not limited to, the idea that a person can go to a garage sale and purchase from the garage sale seller by using a cell phone. Put broadly one peer-to-peer payment embodiment includes the ability for somebody to be able to send a payment to another person whenever and wherever.

### TECHNICAL FIELD

The subject specification relates generally to customer to customer fund transfer methods and apparatus and in particular, to systems and methodologies that allow a person with an associated first mobile device to transfer funds to a second device.

### BACKGROUND

With the ever-increasing popularity of personal mobile devices, e.g., cell phones, smartphones, personal digital assistants (PDAs), personal music players, laptops, etc., ‘mobility’ has been the focus of many consumer products as well as services of wireless providers. For example, in the telecommunications industry, ‘mobility’ is at the forefront, as consumers are no longer restricted by location with regard to communications and computing needs. Rather, today, as technology advances, more and more consumers use portable devices in day-to-day activities, planning and entertainment.

As mobile device popularity increases, the ability to make telephone calls, access electronic mail, communicate via instant message (IM) and access online services from any location has also continued to evolve. Although wireless technology for data transmission has been available for quite some time, service providers have not evolved at the same rate. Thus, the full potential of mobile devices may not be leveraged in today's society.

With credit cards and debit cards the world has been moving to becoming cashless society. Similarly, other technological trends have greatly affected traditional banking. While in the not so recent past, a customer would personally visit a branch bank to receive personal service from a teller, today, these visits happen more and more infrequently. In fact, the popularity of the automatic teller machines (ATMs) was primarily responsible for the first transition from personal teller service. Today, as the Internet continues to grow in popularity, online banking continues to grow and become very successful. More and more, our societies have become mobilized and likewise not dependent on traditional physical financial institutions.

### SUMMARY

The following presents a simplified summary in order to provide a basic understanding of some aspects described herein. This summary is not an extensive overview of the claimed subject matter. It is intended to neither identify key or critical elements of the claimed subject matter nor delineate the scope thereof. Its sole purpose is to present some concepts in a simplified form as a prelude to the more detailed description that is presented later.

The subject innovation, in one aspect thereof, provides for a system that enables funds to be transferred from one individual to another via a peer to peer-like network. For instance, in accordance with the features, functions and benefits of the innovation, a user can automatically (and securely) transfer funds to another individual through the use of a mobile device (e.g., cell phone, smartphone, personal digital assistant (PDA), personal media player).

More particularly, the subject innovation provides for systems and methods that facilitate using a first mobile device to initiate a funds transfer to a second device. One mobile to consumer payment embodiment allows a person to enter into a store and pay for that person's purchases using a cell phone. Other mobile consumer payment embodiments include strictly consumer-to-consumer transactions, for example, but not limited to, the idea that a person can go to a garage sale and purchase from the garage sale seller by using a cell phone. Put broadly one peer-to-peer payment embodiment includes the ability for somebody to be able to send a payment to another person whenever and wherever, as desired.

Accordingly, for example, two people are standing near the 18^{th} hole of a golf course when one person having just lost a bet (in a location where betting is legal) can transfer funds via a mobile device by merely pressing buttons. Subsequently, the other person receives money into their account as well as an acknowledgement via their mobile device. Other payment ideas include allowing a person to interact with one automated teller machine (ATM) at one location and have money sent to an ATM at another location or to a store or to ramp up the credit on a store's own debit or credit card.

In still other aspects, two people can coordinate via their phones where each end up at approximately the same time in front of different ATM machines, and one person can access his account wirelessly and tell the ATM system to output the cash at the other ATM machine where the second person is waiting. The subject innovation provides for systems and methods that employ a user interface that facilitates a first mobile device being used to initiate a funds transfer to a second device. In yet another aspect, the first mobile device can transfer a digital certificate to the second mobile device as an electronic check or e-check which the second device can collect from the first device's associated bank. The transfer of the e-check can be with or without a wireless network.

To the accomplishment of the foregoing and related ends, certain illustrative aspects of the claimed subject matter are described herein in connection with the following description and the annexed drawings. These aspects are indicative of various ways in which the subject matter can be practiced, all of which are intended to be within the scope of the claimed subject matter. Other advantages and novel features may become apparent from the following detailed description when considered in conjunction with the drawings.

### BRIEF DESCRIPTION OF THE DRAWINGS

FIG. 1 illustrates a peer to peer or customer to customer environment sometimes herein referred to as P2P and C2C in accordance with an aspect of the subject innovation.

FIG. 2 illustrates a peer to peer or customer to customer environment which can communicate by way of a financial institution in accordance with an aspect of the subject innovation.

FIG. 3 illustrates an interface component that can include a security component n accordance with an aspect of the subject innovation.

FIG. 4 illustrates a security component that can be used to cryptographically protect (e.g., encrypt) data as well as to digitally sign data, to enhance security and decrease any unwanted, unintentional or malicious disclosure in accordance with an aspect of the subject innovation.

FIG. 5 illustrates a methodology of accepting a transfer in accordance with an aspect of the subject innovation.

FIG. 6 illustrates a methodology where a third-party receives a request from a buyer to send a recipient some funds in accordance with an aspect of the innovation.

FIG. 7 illustrates a methodology where a third-party receives a request to send a recipient some funds in accordance with an aspect of the innovation.

FIG. 8 illustrates a methodology including authenticating the user in accordance with an aspect of the subject innovation.

FIG. 9 illustrates a flow diagram throughout a C2C/P2P transaction in accordance with an aspect of the innovation.

FIG. 10 illustrates a flow diagram throughout a P2P/C2C transaction in accordance with an aspect of the innovation.

FIG. 11 illustrates a brief general description of a suitable computing environment wherein the various aspects of the subject innovation can be implemented.

FIG. 12 illustrates a schematic diagram of a client-server computing environment wherein the various aspects of the subject innovation can be implemented.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding of the subject innovation. It may be evident, however, that the innovation can be practiced without these specific details. In other instances, well-known structures and devices are shown in block diagram form in order to facilitate describing the innovation.

As used in this application, the terms “component” and “system” are intended to refer to a computer-related entity, either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

As used herein, the term to “infer” or “inference” refer generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

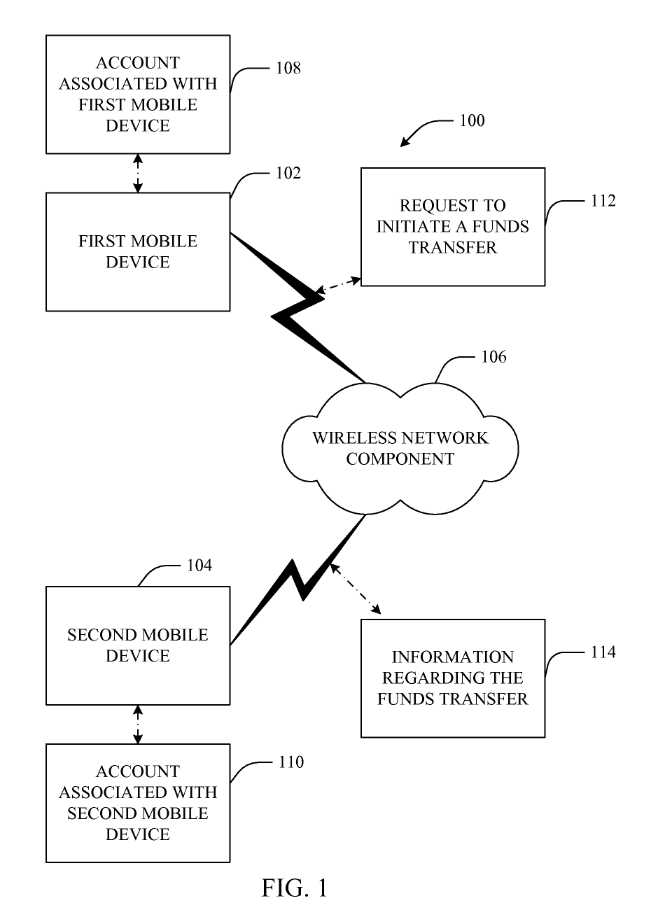

Referring initially to the drawings, FIG. 1 illustrates a peer to peer or customer to customer environment 100 sometimes herein referred to as P2P and C2C environment. A first device 102 is operationally coupled to a second device 104 at least partially via a wireless network 106, for example IEEE 802.11, Bluetooth, WIFI, or the like. In some situations it would be desirable to arrange a transfer of funds to the second device 104 from an account 108 belonging to the owner of the first device 102. This would be especially useful when the first device is a first mobile device 102. Allowing the transference of funds to the second device 104 facilitates the use of the first mobile device 102 as a virtual wallet. When the second device 104 is also a mobile device this facilitates both the first and second devices 102 and 104 being virtual wallets.

One mobile to consumer payment idea is to allow a person to enter into a store and pay for that person's purchases using that person's cell phone. Other mobile consumer payment ideas include consumer to consumer, for example, but not limited to, the idea that a person can go to a garage sale and purchase from the garage sale seller by using a cell phone. In another example, a student (son or daughter) can call their parent and ask for funds which, in accordance with the innovation, can be automatically transferred via the parent's mobile device. Accordingly, the funds can be received via the student's mobile device. Additionally, and still with reference to parents, children, and/or other family members, in one aspect the account can be a pooled account such that several users have access to the pooled account similar to a regular papers checking account with multiple authorized signers.

In one embodiment, the first mobile device can transfer a digital certificate to the second mobile device as an electronic check or e-check which the second device can collect from the first device's associated bank. The transfer of the e-check can be with or without a wireless network. Stated broadly, one peer-to-peer payment idea includes the ability for somebody to be able to send a payment to another person whenever and wherever. For example, two people are standing near the 18^{th} hole of a golf course when one person having just lost a bet (in a location where betting is legal) can employ his mobile device to transfer funds to another person's mobile or stationary device.

Other payment ideas include allowing a person to interact with one automated teller machine (ATM) at one location and have money sent to an ATM at another location or to a store or to ramp up the credit on a store's own debit or credit card. In this scenario, two people can coordinate via their phones where each person ends up at approximately the same time in front of different ATM machines, and one person can access his account with his mobile device and tell the ATM system to output the cash at the other ATM machine where the second person is waiting.

In FIG. 1 the wireless network is envisioned as being at least partially controlled by a cash handling business such as a bank or a system of ATMs. As illustrated in FIG. 1, the second device 104 has an account 110 associated with it. Typically, a request 112 to initiate a funds transfer is sent from the first device 102 to the wireless network component 106. Then typically, information 114 regarding the funds transfer is provided to the second device which may be a mobile device 104. The information sent can be just that someone wishes to send them money. However, typically the amount of the requested funds transfer and the identity of the requester would also be sent. Other information such as invitations, confirmation, authorizations, and/or authentications are described below and can be sent as well.

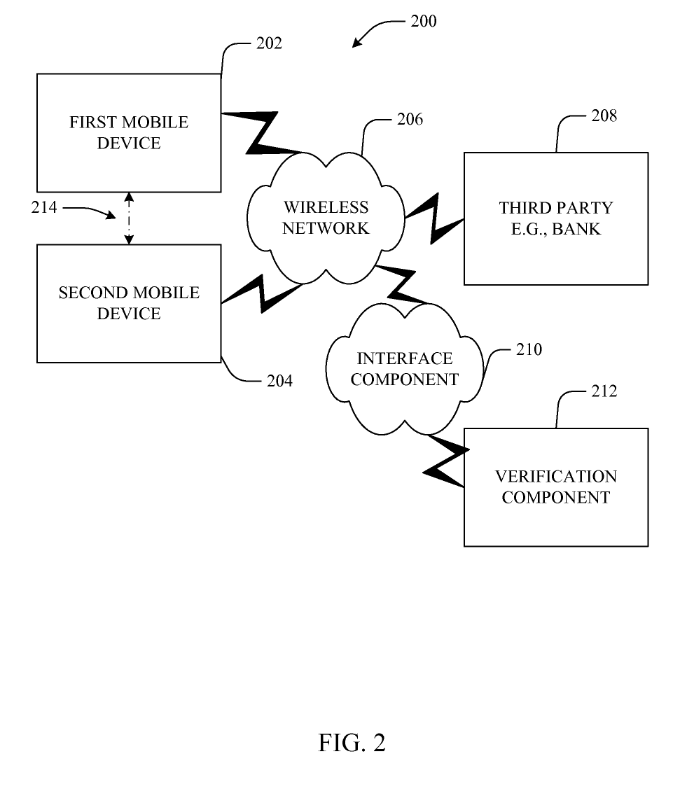

As described below security features can be enabled. For example, one person (person 1) wants to pay a second person (person 2) X dollars. So person 1 pulls out his/her mobile device (e.g., cell phone, smartphone, personal digital assistant (PDA), personal media player) and inputs data into the mobile device to initiate a funds transfer. The mobile device accesses a wireless network 106 (for example IEEE 802.11, Bluetooth, WIFI, or the like) and the access may be secured such that an encryption component as explained in greater detail below cryptographically protects the data during transmission. The encryption component can employ an encryption algorithm to encode data for security purposes. The algorithm is essentially a formula that is used to turn data into a secret code. The request to initiate the funds transfer is communicated to a third party as better explained with reference to FIG. 2. The third party (typically the funds transfer provider) then contacts person 2 and attempts to develop a relationship with person 2 if one does not already exist. Once a relationship exits with person 2 and person 2 agrees to any term/fees that the funds transferer demands, then the funds transferer can transfer funds to an account associated with person 2's mobile device. Of course, the transfer can be a secured transaction as well. And any notifications confirming that the transfer took place can be delivered either secured or unsecured.

Referring now to FIG. 2, also illustrated is a peer to peer or customer to customer environment 200 sometimes herein referred to as P2P and C2C environment. A first device 202 is operationally coupled to a second device 204 at least partially via a wireless network 206 and to a third-party 208. FIG. 2 illustrates the concept where either complete or near strangers are people with the first mobile device 202 and the second device 204. For example, the first mobile device 202 carrier (a user) could bank with the third-party 208, and the second device 204 can be at a point of sale (POS), such as, but not limited to, a shopping mall or large store or small store.

The third-party can be a large entity with such a reputation that the owner of the second device 204 knows it will be paid if the third party says it will be paid. Accordingly, the owner of the first device 202 can select products to purchase, approach the POS, communicate the desire of the purchase via the first mobile device 204, the third-party 208 approves the purchase, and communicates that approval to the second device 204. The consumer can then leave the store. However sometimes, the owner of the second device 204 desires cash. In this case, one way to obtain the desired result is for the third-party 208, a bank for example, to open an account for the owner of the second device 204, deposit money into the account, and then inform the owner of the second device 204 that the money was deposited.

It is contemplated that the benefits of the innovation accrue to embodiments where the third-party 208 is a non-banking entity. However, many times the third-party 208 is someone the owner of the second device 204 trusts or has a business relationship with. In one example, the third-party 208 is a phone company, the second device 204 is a mobile cell phone, and the fund transfer can be applied against bills of the third-party 204 that reduce what the owner of the second device 204 pays for service. Alternatively, it could be a combination, such as a combined e-space e-mail account tied to a banking account which is tied to a cell phone account, and any unused minutes from a phone plan having allotted minutes per allotted timeframe could be refunded back to the e-space banking account.

Additionally, the third party can be financial institution such as a bank or credit union where people with an account native to the financial institutional (e.g., an account opened directly with the bank or credit union) can deposit and withdraw cash at a teller window or an ATM machine. FIG. 2 also illustrates an interface component that the first and second devices 202, 204 and the third party 208 can communicate to each other through. Although illustrates as a separate entity, it is envisioned that some portions of the interface component 210 will be collocated with the first and second devices 202, 204 and/or the third party 208. As used herein the term e-space account refers to most all banking accounts that have a secured e-mail address associated therewith by the banking institution and assigned to the user by the banking institution. A verification component 212 is in some aspects capable of providing authentications and/or verifying authorizations and. The bank 208 is the funds transfer provider. It should be noted that in FIG.2 reference 214 references that the first mobile device 202 and the second mobile device 204 can be communicatively coupled independent of the wireless network component 206.

In yet another aspect of the subject innovation, the first mobile device can transfer a digital certificate to the second mobile device as an electronic check or e-check which the second device can collect from the first device's associated bank. The transfer of the e-check can be with or without a wireless network. For example, the two devices talk to each other forming a network of two mobile devices and then the e-check is transferred.

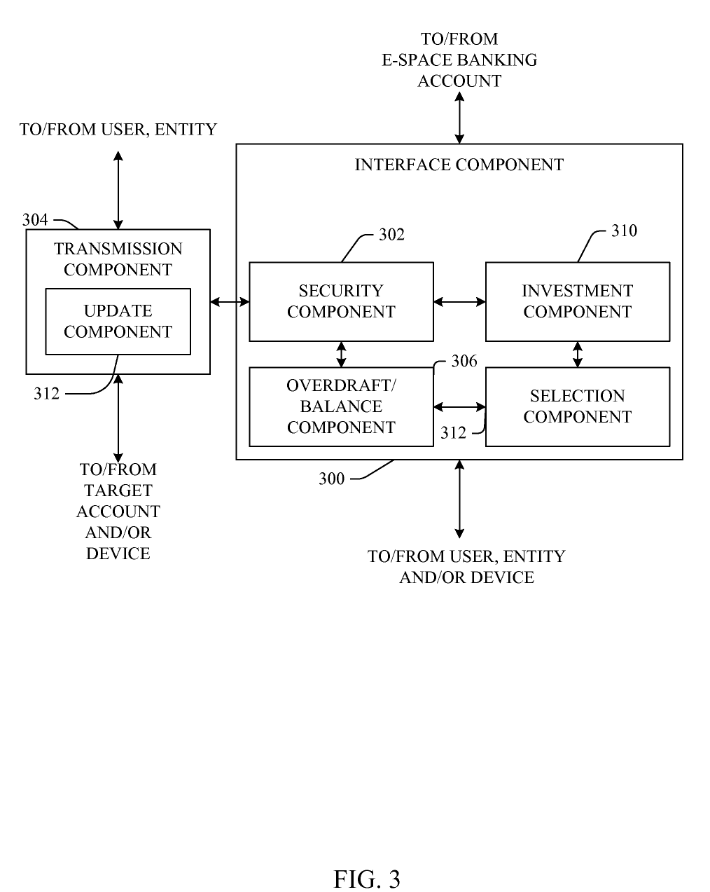

Turning now to FIG.3, a block diagram of an interface component 300 is shown. Generally, the interface component 300 can include a security component 302 in communication with a transmission component 304 and an overdraft/balance component 306. As described herein, together, these components enable a user or other entity (e.g., enterprise, downstream financial institution) to securely transfer funds associated with an e-space banking account. Additionally, the overdraft/balance component 306 can allow the entity to check their balance and in some cases transfer more funds than the balance shows via an overdraft protection. A fee or charge may be associated with the overdraft protection. As will be described infra, access (e.g., authentication) can be controlled by a management component. While these components are illustrated as separate components, it is to be understood that all or a subset of the components (and corresponding functionality) can be collocated in alternative aspects without departing from the spirit and/or scope of the innovation described and claimed herein.

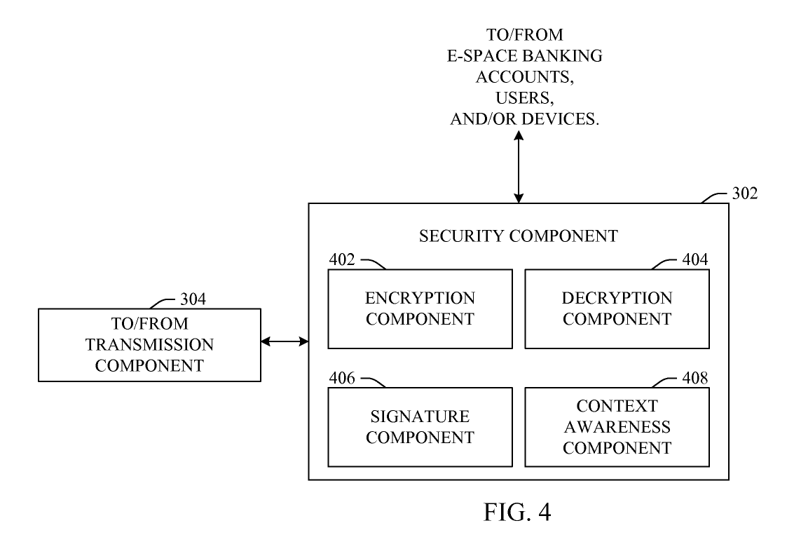

The security component 302 can protect information transmitted and/or received to/from the e-space account. For instance, the security component 302 can employ cryptographic mechanisms to deter or avoid unintentional or malicious disclosure of data. As will be described in connection with FIG. 4 below, the security component can also enable digital signatures as well as contextual awareness. These features enhance the sophistication and security of the funds transfer functionality.

To further illustrate that both an application running on a server and the server can be a component and that one or more components can reside within a process and/or thread of execution, and a component can be localized on one computer and/or distributed between two or more computers, FIG. 3 illustrates both interface component 300 and transmission component 304 being in communication with the users and their accounts/devices. It should be appreciated that interface component 300 and transmission component 304 can be a single component. In one aspect of the subject innovation an update component 312 is provided.

The update component 312 can proactively update mobile devices with balance amounts. For example, the first mobile device is updated at 1 am as having $200.00 available, and at 1:30 am, the first user makes a purchase with a $50.00 value. The first mobile device tells the second device something similar to ‘I'm paying you $50.00’ or ‘I want to send you an e-check for $50.00’, and the second device accepts the transfer or check and increases its balance accordingly. Then at 2:00 am when update component 312 performs another update, and this information is passed on to the financial institutions associated with the accounts, or in the e-check example the e-check is effectively cashed. The update component can be periodically employed with any period of periodicity. This is best thought of as a pushing operation as opposed to the previously described pulling operation. In other words, when the bank via the wireless network receives a funds transfer request and then verifies, authenticates, etc. and performs the transfer, that can be considered a pulling transfer. However when the devices themselves effectuate the transfer and then later the bank or financial institution learns of the transfer, this is a pushing transfer.

Additionally, instead of deposit accounts as described above, lines of credit can be employed. For example, the first mobile device is updated at 1 am as having a credit line of $200.00 available, and at 1:30 am, the first user makes a purchase with a $50.00 value. The first mobile device tells the second device I'm paying you $50.00, the second device accepts the transfer and increases its balance accordingly, then at 2:00 am when update component 312 performs another update, and this information is passed on to the financial institutions associated with the accounts, such that the line of credit is now $150.00. In one embodiment there is a voice-recognition unit (VRU) and the first mobile device user can effectuate the funds transfer initiation through voice commands as opposed to pushing buttons on the mobile device. In another embodiment the mobile device is hardened to withstand harsh conditions and is usable in wet environments, relatively hot environments, and below freezing environments.

Additionally, in both the deposit account example and the line of credit example, and as better explained below, device contextual factors can be established, for example, location of transaction, owner, what security protocols are/were employed, whether the request arrived from public or private network, etc. This contextual awareness can assist in both the effective rendering of the data as well as adding another layer of access security. Still further, and regardless of in the content of deposit account or line of credit, the world is getting smaller with more people traveling all the time. The first mobile device can have a balance of $200.00, but the device (and person) are in a location not within the United States. The foreign county may use a currency other than the dollar, and as explained in greater detail below a currency conversion can automatically be performed in that situation.

An investment component 310 allows deposited funds to be invested in investment vehicles such as certificates of deposits or mutual funds. A selection component 310 can be employed to facilitate the selection of any particular investment vehicle. The selection component can also be employed to select desired security levels, or an amount of desired overdraft protection requested or other services that is available for an account holder to select.

Turning now to FIG. 4, as described above, security component 302 can be used to cryptographically protect (e.g., encrypt) data as well as to digitally sign data, to enhance security and decrease any unwanted, unintentional or malicious disclosure. In operation, the security component 302 can communicate data to and from the transmission component 304. Essentially, the security component 302 enables funds transfer data to be protected while transmitting to the mobile devices, the e-space accounts, the users, as well as any third party wherein the mobile devise can be any of a cell phone, a camera, a smartphone, a personal digital assistant (PDA), a personal media player, a music player, and/or a portable recording device either audio or visual, and combinations thereof of the listed functionalities.

An encryption component 402 can be used to cryptographically protect data during transmission as well as while stored. The encryption component 402 employs an encryption algorithm to encode data for security purposes. The algorithm is essentially a formula that is used to turn data into a secret code. Each algorithm uses a string of bits known as a ‘key’ to perform the calculations. The larger the key (e.g., the more bits in the key), the greater the number of potential patterns can be created, thus making it harder to break the code and descramble the contents of the data.

Most encryption algorithms use the block cipher method, which codes fixed blocks of input that are typically from 64 to 128 bits in length. A decryption component 404 can be used to convert encrypted data back to its original form. In one aspect, a public key can be used to encrypt data upon transmission to the mobile devices, the e-space accounts, the users, as well as any third party. Upon retrieval, the data can be decrypted using a private key that corresponds to the public key used to encrypt.

A signature component 406 can be used to digitally sign data and documents when transmitting and/or retrieving from any electronic storage source in order to transfer funds or check balances. It is to be understood that a digital signature guarantees that a file has not been altered, similar to as if it were carried in an electronically sealed envelope. The ‘signature’ is an encrypted digest (e.g., one-way hash function) used to confirm authenticity of data. Upon accessing the data, the recipient can decrypt the digest and also re-compute the digest from the received file or data. If the digests match, the file is proven to be intact and tamper free. In operation, digital certificates issued by a certification authority are most often used to ensure authenticity of a digital signature. In one embodiment, the first mobile device includes a certified digital certificate that it can directly transfer to the second device, and the second device can then redeem the digital certificate with its associated financial institution for cash or as part of a deposit.

Still further, the security component 302 can employ contextual awareness (e.g., context awareness component 408) to enhance security. For example, the contextual awareness component 408 can be employed to monitor and detect criteria associated with data transmitted to and requested from a mobile device or an e-space account. In operation, these contextual factors can be used to filter spam, control retrieval (e.g., access to highly sensitive data from a public network), or the like. It will be understood that, in aspects, the contextual awareness component 408 can employ logic that regulates transmission and/or retrieval of data in accordance with external criteria and factors.

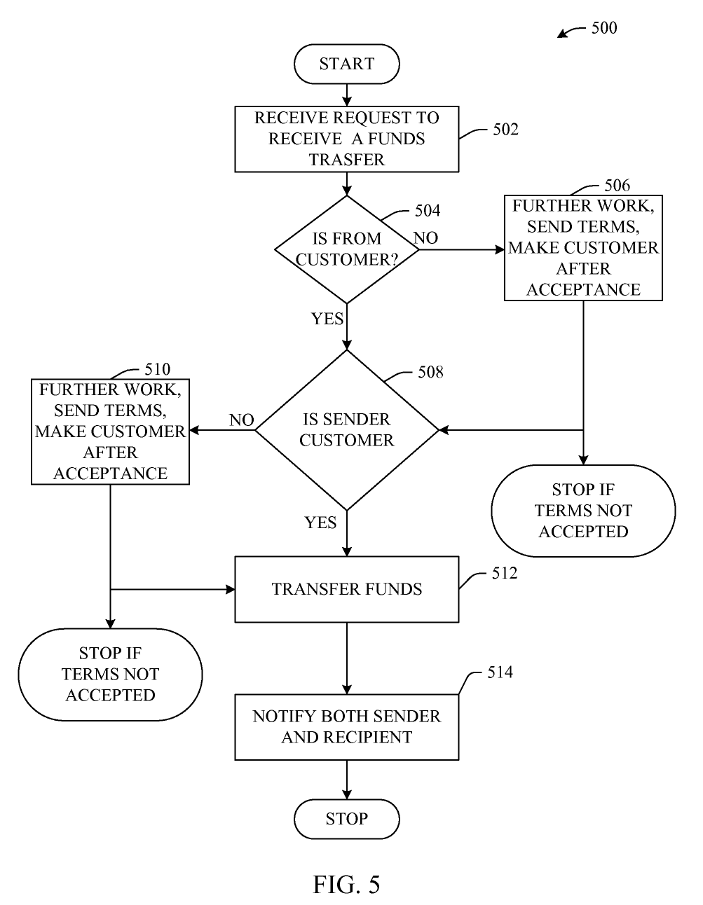

Referring now to FIG. 5 there is illustrated an example methodology 500 second device (the receiving device) is initiating the transfer request. While, for purposes of simplicity of explanation, the one or more methodologies shown herein, e.g., in the form of a flow chart, are shown and described as a series of acts, it is to be understood and appreciated that the subject innovation is not limited by the order of acts, as some acts may, in accordance with the innovation, occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the innovation.

Methodology 500 is where instead of the first mobile device initiating the funds transfer; the second device (the receiving device) is initiating the transfer request. First, at act 502, is receiving a request to receive a funds transfer. This is where the third-party receives a request to send a recipient some funds. In other words, to make a funds transfer to a recipient requested by the recipient. This is the example of the funds transfer being initiated by a seller. At a decision act 504, it is determined if this is from a customer or not meaning an established customer as opposed to a potential new customer. If no, then at act 506, further work is to be done. The terms of the transaction are sent to the recipient and the recipient is made a customer after acceptance of the terms. If the recipient does not accept the terms then further action is stopped.

However, if the recipient did accept the terms and was made a customer at act 506 or was already a customer from decision 504, now a decision act 508 is to determine is the buyer (sender) a customer. Again like what was done for the recipient, if the buyer is not a current customer than further work is to be done at act 510. First, is to send the terms of the transaction to the buyer and second, is to make the buyer a customer after acceptance of the terms. If the buyer does not accept the terms then further action is stopped.

However, if the buyer did accept the terms and was made a customer at act 510 or was already a customer from decision 508, now the funds are transferred at act 512. Additionally, at act 514 either of the sender and recipient are notified that the funds are transferred. In one embodiment, the sender and recipient are notified via e-mail to the first mobile device and the second device. It will be understood and appreciated that notification can be effected in most any protocol, including but not limited to email, instant message, text message, telephonic call, etc. without departing from the spirit and/or scope of the innovation. Typically, if the recipient was not a prior customer, but did accept the terms, the recipient would be required to provide the third-party was sufficient credit card or debit card information such the third-party can guarantee it will get paid, prior to placing any funds in any account associated with the second device.

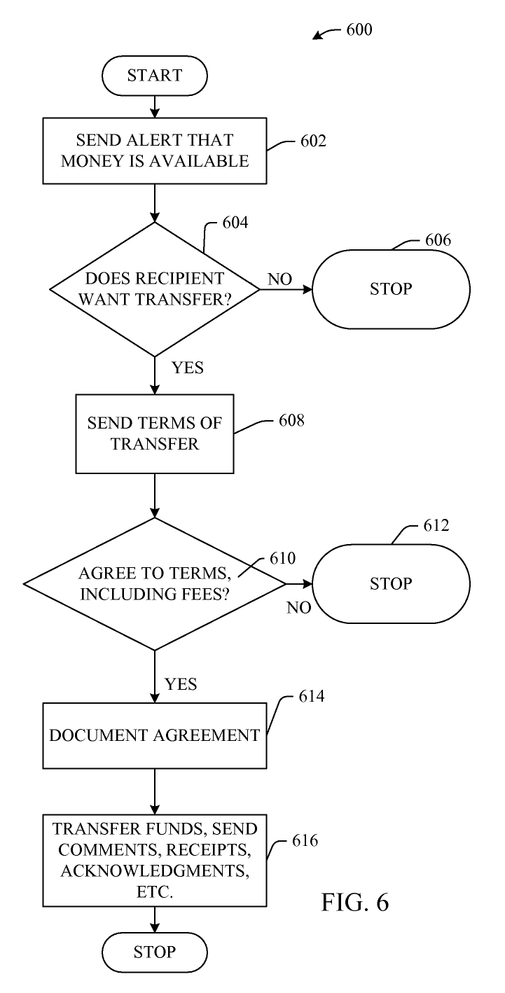

Referring now to FIG. 6 there is illustrated a methodology 600 to of facilitating that the third-party receives a request from a buyer to send a recipient some funds. In other words, the bank is being asked to make a funds transfer to the recipient from the buyer. Here at act 602, the third party sends an alert that money is available, this alert is sent to a potential recipient. It will be understood and appreciated that alert can be effected in most any protocol, including but not limited to email, instant message, text message, telephonic call, etc. without departing from the spirit and/or scope of the innovation. At decision block 604, there is a decision to be made whether the recipient wants the transfer. Typically, the information sent to the intended recipient includes the amount of the desired funds transfer as well as the identity of the requester.

If no, then all activity stops at 606. If yes, then at act 608 the terms of the transfer are sent to the potential recipient. The terms can include fees for the funds transfer. At decision block 610, the decision is does the recipient agree to the terms including any proposed fees. As before, if no agreement, then the methodology stops at 612. And if agreement to the terms, then at act 614, agreement is documented, either via return e-mail saying yes, or via a fourth-party company that the operator hands off a phone conversion to and verifies the decision to accept the terms or is otherwise documented.

Then at act 616 the funds are transferred, and any comments, receipts, acknowledgments, etc. are sent to both the seller (recipient) and the buyer (initiator). If a person does not have an account with this bank (the third party) and that person wishes to send money, the bank still wants to give that person the ability to do so, so the bank will create an account for that person. The subject innovation, in one aspect thereof, provides for a system that enables a person that is on a road traveling and sees on a bulletin board a message saying ‘if you want to send money to a friend just enter this code into your cell phone.’ After the person enters the code into the cell phone they will get back a response from the bank saying we do recognize the user as a customer or we do not recognize the user as a customer, if the user is a customer and we will go ahead and set the user up on a path to send the user's recipient money from the user's account. If the user is not a customer then the user will receive contact information such as a phone number for the user to call back on, and/or the user's cell phone number which would have been transmitted or which can have been transmitted automatically with the code or e-mail or was otherwise provided to the bank can be used by the bank to contact the user. Or the non-customer will receive a call back with a person ready to take credit card information and initiate the fund transfer.

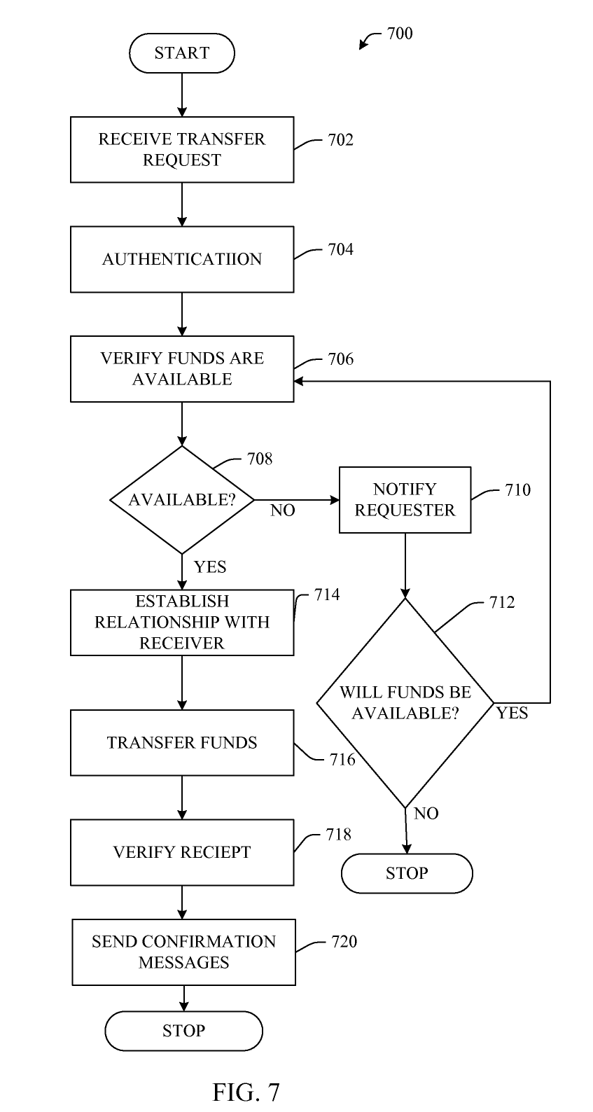

Referring now to FIG. 7 there is illustrated a methodology 700 wherein first, at act 702, is receiving a transfer request. This is where the third-party receives a request to send a recipient some funds. In other words, the third party is being asked to make a funds transfer to a recipient from a requester. This can be an example of the funds transfer initiated by a purchaser or by the seller. At act 704, an authentication is done. This can be authenticating the device is the proper device and not a stolen device with false account information. This can be authenticating the device is in an authorized user's possession through authenticating the user.

Essentially, here, digital identity of the user can be established to permit access to being part of a funds transfer. As described herein, most any authentication mechanisms can be employed in accordance with aspects of the innovation. In addition to establishing the digital identity of a user or user's device, authentication mechanisms might employ challenge/response mechanisms, out-of-band password access, third party intervention, etc.

In other words, the innovation can employ redundancy mechanisms in order to ensure or enhance security of the funds transfer. Still further, additional human authentication factors can be used to enhance security. For instance, biometrics (e.g., fingerprints, retinal patterns, facial recognition, DNA sequences, handwriting analysis, voice recognition) can be employed to enhance authentication to control access to any funds transferring ability. It will be understood that embodiments can employ multiple factor tests in authenticating identity of a user.

At act 706, the funds can be verified to be available. If not available at decision 708, the requester is notified at 710, and it is determined at 712 if the funds will be available soon and if so then logic flow returns to act 706 to verify that the funds are available. Once it is determined at 708 that the funds are available then a relationship is established with the receiver at 714. After the relationship is established (terms fees accepted etc.) then the funds are transferred at act 716. After verifying receipt of the transferred funds at act 718, then confirmation messages are sent at 720. The confirmation messages can be sent to either or both of the sender and the recipient of the funds transfer.

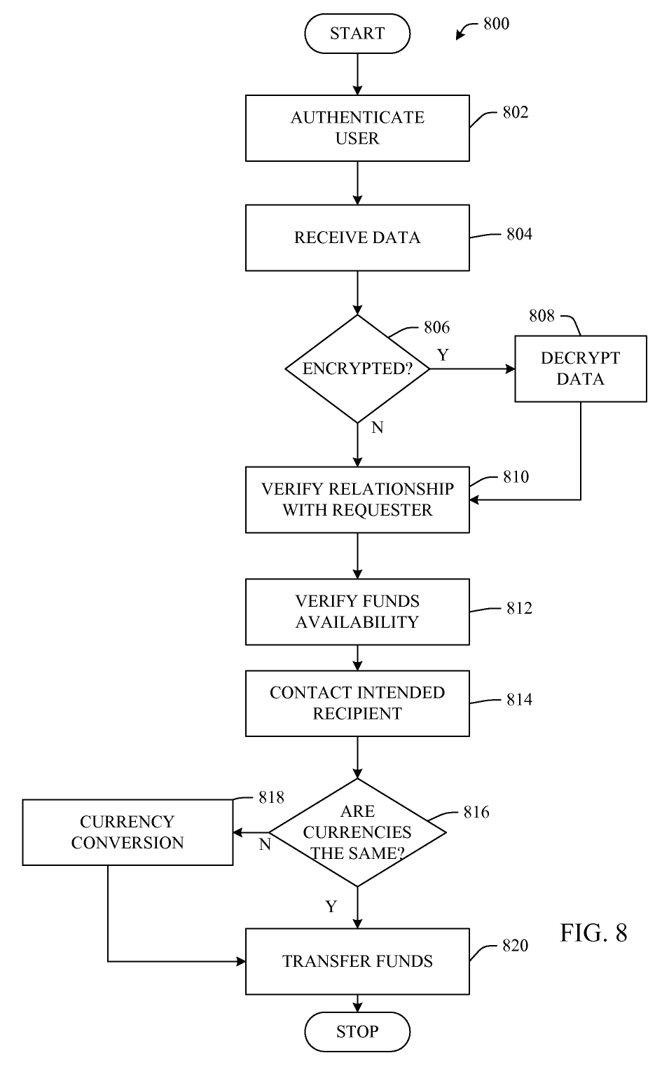

Referring now to FIG. 8 there is illustrated a methodology 800 wherein first, at act 802, includes authenticating the user. This can be authenticating the device is in an authorized user's possession through authenticating the user as mentioned above and most any authentication mechanisms can be employed in accordance with aspects of the innovation. After authenticating the user, data is received at 804 regarding a desired funds transfer. The data is examined to determine 806 if it is encrypted or not. In either situation (e.g., encrypted or not encrypted) context of the user and/or device can optionally be established. For example, sensory technologies can be employed to establish environmental context such as, location, date, time of day, engaged activity, etc.

Additionally, device contextual factors can be established, for example, location of either the first or second device, identity of device owner, location of device owner, history of device owner, security protocols, whether the request for funds transfer came form a public or a private network, etc. This contextual awareness can assist in both the effective rendering of the data as well as adding another layer of access security. If encrypted, then the data is decrypted at 808. A relationship is verified to see if there is a relationship with the requester. In other words, the first check is whether the person in possession of the device is the owner, then it verifies if the owner is a customer, and then it is verified if the funds are available at 812.

At 814 the intended recipient is contacted and it is determined at 816 if the currencies are the same or not. If not then a currency conversion is performed at 818. Lastly the funds are transferred at 820. Confirmation messages can be sent to either or both of the initiator and the non-initiator of the funds transfer. In one aspect, a fee is charged when a currency conversion is done. Additionally, in one aspect, upon deciding that a currency conversion is necessary, the requestor of the funds transfer is informed and allowed to rescind the request or acquiesce to the conversion and pay the conversion fee. In another embodiment, the intended receiver is notified that a currency conversion will be required to transfer the funds and the recipient is given the choice to either cancel the transfer or acquiesce to the conversion and paying the conversion fee.

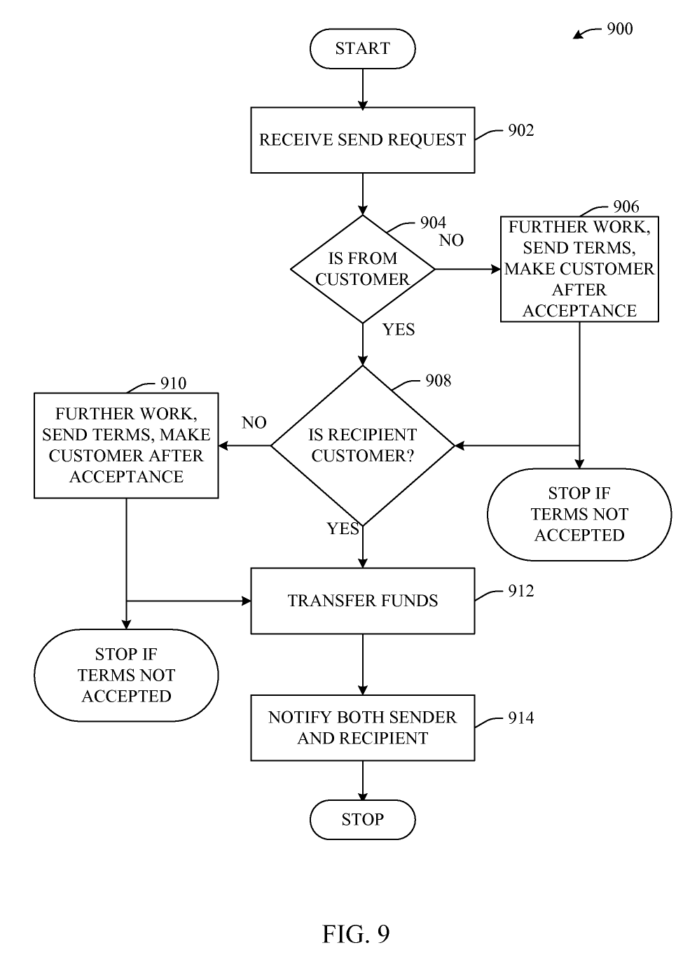

Referring to FIG. 9 is a methodology wherein at act 902, is receiving a send request. This is where the third-party receives a request to send a recipient some funds. In other words, the third party is being asked to make a funds transfer to a recipient from a requester. This can be an example of the funds transfer initiated by a purchaser. At act 904, it is determined if the transfer is from a customer, meaning an established customer. If no, then at act 906, further work is to be done. First, the terms of the transaction are sent to the requester and second, the requester can be signed on as a customer after acceptance of the terms. If the requester does not accept the terms then further action is stopped.

However, if the requester did accept the terms and was made a customer at act 906 or was already a customer from decision 904, now a decision act 908 is to determine if the recipient is a customer. Again, like what was done for the requester, if the recipient is not a current customer, further work is to be done at act 910. First is to send the terms of the transaction to the recipient and second is to make the recipient a customer after acceptance of the terms. If the recipient does not accept the terms then further action is stopped.

However, if the recipient did accept the terms and was made a customer at act 910 or was already a customer from decision 908, the funds are transferred at act 912. Additionally, at act 914 both the sender and recipient are notified that the funds are transferred. In one embodiment, the sender and recipient are notified via e-mail to the first mobile device and the second device. It will be understood and appreciated that notification can be effected in most any protocol, including but not limited to email, instant message, text message, telephonic call, etc. without departing from the spirit and/or scope of the innovation.

Typically, if the requester was not a prior customer, but did accept the terms, the requester could be required to provide the third-party with sufficient credit card or debit card information such the third-party can guarantee it will get paid, prior to placing any funds in any account associated with the second device. To be clear, the third party does not necessarily collect funds before it places funds, the third party just receives assurances that it will get paid from at least one fourth party that the third party trusts.

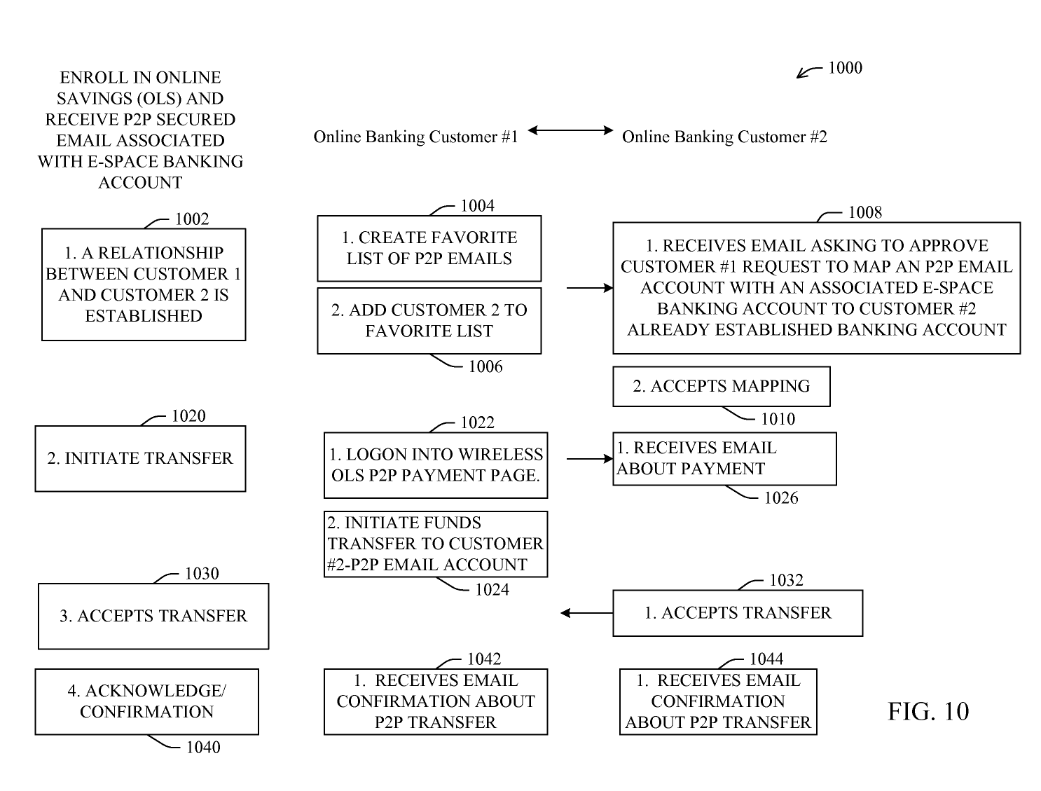

FIG. 10 illustrates a schema where there are two online banking customers #1 and #2 that have the ability to enroll in an online savings account and receive a P2P secured email account associated with a e-space banking account. As used herein the term e-space banking account refers to all banking accounts that have a secured e-mail address associated therewith by the banking institution and assigned to the user by the banking institution. The schema is illustrated with more general descriptions on the left, actions of the second banking customer on the right, and actions of the first banking customer in the middle.

At act 1002, a relationship from customer #1 to customer #2 is established. More specifically at act 1004, first customer #1 creates a favorite list of peer-to-peer e-mail addresses. At act 1006, the customer adds customers to the favorite list such as customer #2. Customer #2 first receives e-mail at act 1008 asking to approve the customer #1's request to map a P2P e-mail account with the associated e-space banking account to customer #2 who was already an established banking account customer. If customer #2 is not already a customer, then that person is invited to become a customer. Second at act 1010, customer #2 accepts the mapping. Second at general act 1020, a transfer is initiated. Customer #1 at act 1022, logons to a wireless online savings (OLS) P2P payment page and secondly initiates a fund transfer to customer #2 or more specifically to his P2P e-mail account at act 1024. Customer #2 receives the e-mail about the payment at act 1026 and accepts the transfer at act 1032, which is reported generally at act 1030. Acknowledgments and confirmations are sent at act 1040. More specifically, customer #1 receives an e-mail confirmation about the P2P transfer at act 1042 and customer #2 receives an e-mail confirmation about the P2P transfer at act 1044.

The herein described methods and apparatus allow for cross-selling opportunities to gain new customers. By being able to invite an intended recipient of a funds transfer, the number of customers will rise. Emergency currency transfers is hereby facilitated because using a mobile device to effectuate the transfer will speed up the transfer. People can use their mobile devices to requests account balances which can be an SMS (short message service) balance request to as an additional time saver. SMS based banking for non-customers is enabled.

Additional products in addition to balance transfers between mobile devices are herein provided. For example, mobile billing, the mobile delivery of interest rates, instant loans based on applications from the mobile devices, and CD maturity alerts can be e-mailed out to cell phones or other mobile devices.

Mini statements can be accessible to e-space accounts. For example, a user can check the user's balance before making a purchase. Check verification can be easily accessed with or without the e-check feature. Electronic document signing and electronic document retrieval can be done both by users and other entities. RFID (radio frequency identification) with GPS (global positioning satellite) can be available and can aid in emergencies. Of course many non-e-check services or features such as extreme environment banking is also available as is rounding up for social desires can be employed. Digital vaulting capabilities can be provided.

E-space account holders can add people to their account (as explained with reference to pooled accounts) and they can buy and sell brokerage from their mobile devices. E-space account holders can make their account a family deposit account. E-space account holders can initiate a stop payment service. E-space account holders can manage payment due dates or Equated Monthly Installments due (EMI). Bill pay is facilitated both mobile and online. The bank can limit per day and/or per transfer amounts if desired. Or the user can limit per day and/or per transfer amounts if desired. Both parties have record of all transfers. The credit could be same day with the existing EZ network or coming next day with the existing ACH network. In one embodiment there is a voice-recognition unit (VRU).

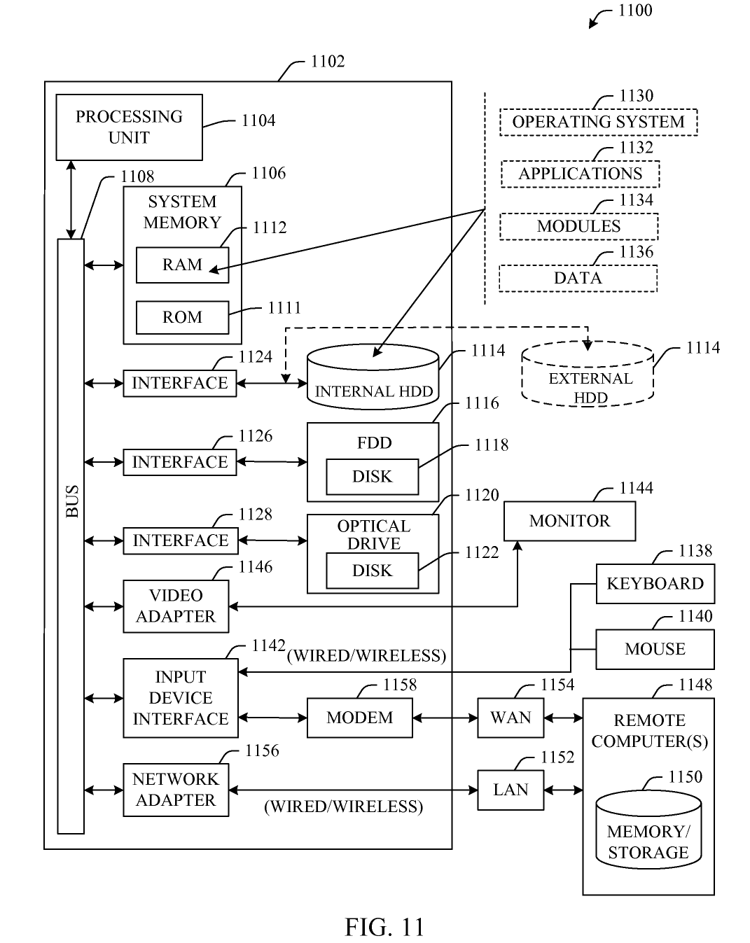

Referring now to FIG. 11, there is illustrated a block diagram of a computer operable to execute the disclosed architecture. In order to provide additional context for various aspects of the subject innovation, FIG. 11 and the following discussion are intended to provide a brief, general description of a suitable computing environment 1100 in which the various aspects of the innovation can be implemented. While the innovation has been described above in the general context of computer-executable instructions that can run on one or more computers, those skilled in the art will recognize that the innovation also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the innovation can also be practiced in distributed computing environments where certain tasks are performed by remote processing devices that are linked through a communications network. In a distributed computing environment, program modules can be located in both local and remote memory storage devices.

A computer typically includes a variety of computer readable media. Computer readable media can be any available media that can be accessed by the computer and includes both volatile and nonvolatile media, removable and non-removable media. By way of example, and not limitation, computer-readable media can comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD ROM, digital versatile disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

With reference again to FIG. 11, the exemplary environment 1100 for implementing various aspects of the innovation includes a computer 1102, the computer 1102 including a processing unit 1104, a system memory 1106 and a system bus 1108. The system bus 1108 couples system components including, but not limited to, the system memory 1106 to the processing unit 1104. The processing unit 1104 can be any of various commercially available processors. Dual microprocessors and other multi processor architectures can also be employed as the processing unit 1104.

The system bus 1108 can be any of several types of bus structure that can further interconnect to a memory bus (with or without a memory controller), a peripheral bus, and a local bus using any of a variety of commercially available bus architectures. The system memory 1106 includes read-only memory (ROM) 1110 and random access memory (RAM) 1112. A basic input/output system (BIOS) is stored in a non-volatile memory 1110 such as ROM, EPROM, EEPROM, which BIOS contains the basic routines that help to transfer information between elements within the computer 1102, such as during start-up. The RAM 1112 can also include a high-speed RAM such as static RAM for caching data.

The computer 1102 further includes an internal hard disk drive (HDD) 1114 (e.g., EIDE, SATA), which internal hard disk drive 1114 can also be configured for external use in a suitable chassis (not shown), a magnetic floppy disk drive (FDD) 1116, (e.g., to read from or write to a removable diskette 1118) and an optical disk drive 1120, (e.g., reading a CD-ROM disk 1122 or, to read from or write to other high capacity optical media such as the DVD). The hard disk drive 1114, magnetic disk drive 1116 and optical disk drive 1120 can be connected to the system bus 1108 by a hard disk drive interface 1124, a magnetic disk drive interface 1126 and an optical drive interface 1128, respectively. The interface 1124 for external drive implementations includes at least one or both of Universal Serial Bus (USB) and IEEE 1394 interface technologies. Other external drive connection technologies are within contemplation of the subject innovation.

The drives and their associated computer-readable media provide nonvolatile storage of data, data structures, computer-executable instructions, and so forth. For the computer 1102, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, can also be used in the exemplary operating environment, and further, that any such media can contain computer-executable instructions for performing the methods of the innovation.

A number of program modules can be stored in the drives and RAM 912, including an operating system 1130, one or more application programs 1132, other program modules 1134 and program data 1136. All or portions of the operating system, applications, modules, and/or data can also be cached in the RAM 1112. It is appreciated that the innovation can be implemented with various commercially available operating systems or combinations of operating systems.

A user can enter commands and information into the computer 1102 through one or more wired/wireless input devices, e.g., a keyboard 1138 and a pointing device, such as a mouse 1140. Other input devices (not shown) can include a microphone, an IR remote control, a joystick, a game pad, a stylus pen, touch screen, or the like. These and other input devices are often connected to the processing unit 1104 through an input device interface 1142 that is coupled to the system bus 1108, but can be connected by other interfaces, such as a parallel port, an IEEE 1394 serial port, a game port, a USB port, an IR interface, etc.

A monitor 1144 or other type of display device is also connected to the system bus 1108 via an interface, such as a video adapter 1146. In addition to the monitor 1144, a computer typically includes other peripheral output devices (not shown), such as speakers, printers, etc.

The computer 1102 can operate in a networked environment using logical connections via wired and/or wireless communications to one or more remote computers, such as a remote computer(s) 1148. The remote computer(s) 1148 can be a workstation, a server computer, a router, a personal computer, portable computer, microprocessor-based entertainment appliance, a peer device or other common network node, and typically includes many or all of the elements described relative to the computer 1102, although, for purposes of brevity, only a memory/storage device 1150 is illustrated. The logical connections depicted include wired/wireless connectivity to a local area network (LAN) 1152 and/or larger networks, e.g., a wide area network (WAN) 1154. Such LAN and WAN networking environments are commonplace in offices and companies, and facilitate enterprise-wide computer networks, such as intranets, all of which can connect to a global communications network, e.g., the Internet.

When used in a LAN networking environment, the computer 1102 is connected to the local network 1152 through a wired and/or wireless communication network interface or adapter 1156. The adapter 1156 can facilitate wired or wireless communication to the LAN 1152, which can also include a wireless access point disposed thereon for communicating with the wireless adapter 1156.

When used in a WAN networking environment, the computer 1102 can include a modem 1158, or is connected to a communications server on the WAN 1154, or has other means for establishing communications over the WAN 1154, such as by way of the Internet. The modem 1158, which can be internal or external and a wired or wireless device, is connected to the system bus 1108 via the serial port interface 1142. In a networked environment, program modules depicted relative to the computer 1102, or portions thereof, can be stored in the remote memory/storage device 1150. It will be appreciated that the network connections shown are exemplary and other means of establishing a communications link between the computers can be used.

The computer 1102 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

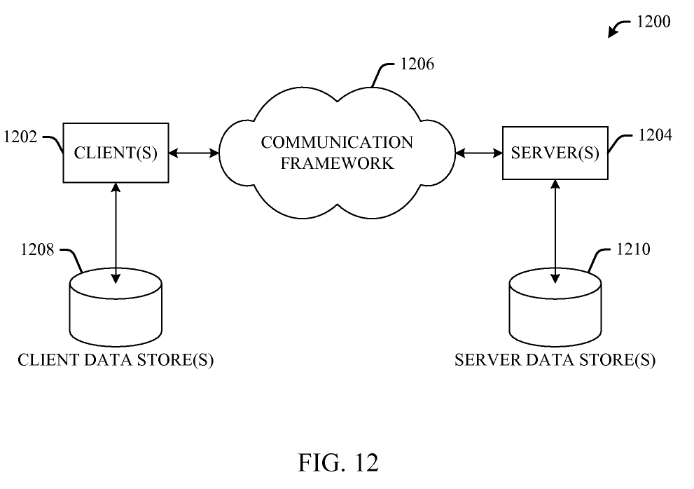

Referring now to FIG. 12, there is illustrated a schematic block diagram of an exemplary computing environment 1200 in accordance with the subject innovation. The system 1200 includes one or more client(s) 1202. The client(s) 1202 can be hardware and/or software (e.g., threads, processes, computing devices). The client(s) 1202 can house cookie(s) and/or associated contextual information by employing the innovation, for example.

The system 1200 also includes one or more server(s) 1204. The server(s) 1204 can also be hardware and/or software (e.g., threads, processes, computing devices). The servers 1204 can house threads to perform transformations by employing the innovation, for example. One possible communication between a client 1202 and a server 1204 can be in the form of a data packet adapted to be transmitted between two or more computer processes. The data packet can include a cookie and/or associated contextual information, for example. The system 1200 includes a communication framework 1206 (e.g., a global communication network such as the Internet) that can be employed to facilitate communications between the client(s) 1202 and the server(s) 1204.

Communications can be facilitated via a wired (including optical fiber) and/or wireless technology. The client(s) 1202 are operatively connected to one or more client data store(s) 1208 that can be employed to store information local to the client(s) 1202 (e.g., cookie(s) and/or associated contextual information). Similarly, the server(s) 1204 are operatively connected to one or more server data store(s) 1210 that can be employed to store information local to the servers 1204.

What has been described above includes various exemplary aspects. It is, of course, not possible to describe every conceivable combination of components or methodologies for purposes of describing these aspects, but one of ordinary skill in the art may recognize that many further combinations and permutations are possible. Accordingly, the aspects described herein are intended to embrace all such alterations, modifications and variations that fall within the spirit and scope of the appended claims.

Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system comprising:
a wireless network component operationally coupled to a first mobile device, wherein the wireless network component:
receives from the first mobile device a request to initiate a funds transfer from an account native to a financial institution to an account associated with a second mobile device; and
sends the second mobile device information regarding the initiated funds transfer.

2. The system of claim 1, wherein the information sent to the second device comprises a set of terms, and wherein the wireless network component further configured to only authorize the funds transfer after a verification component receives an acceptance to the sent terms.

3. The system of claim 2, wherein the wireless network component sends a notification to the first mobile device when the verification component does receive an acceptance to the sent terms.

4. The system of claim 1, wherein the wireless network component receives an indication that the second mobile device will be associated with an account of a funds transfer provider.

5. The system of claim 1, further comprising an authorization component that validates at least one of the first mobile device being in possession of an authorized user with an authorized account and the second mobile device being in possession of an authorized user with an authorized account.

6. The system of claim 1, wherein the wireless network component notifies both the first mobile device and the second mobile device that the transfer is complete after validating that the account associated with the second mobile device received the funds.

7. The system of claim 1, wherein the first mobile device comprises a telephone and the wireless network component credits unused minutes from a calling plan to the native account that comprises an e-space bank account associated with the first mobile device.

8. The system of claim 1, wherein the wireless network component verifies an amount available to the native account associated with the first mobile device and gives a pre bounce warning to the first device if the amount available is less than an amount of funds requested transferred.

9. The system of claim 1, wherein the wireless network component further performs a currency conversion.

10. The system of claim 1, wherein the wireless network component performs an authentication to confirm an identity of a person possessing the first mobile device.

11. A method comprising:
wirelessly coupling with a first mobile device; and
wirelessly receiving information regarding an initiated funds transfer initiated at the first mobile device regarding a first account native at a financial institution.

12. The method of claim 11, further comprising notifying a second mobile device associated with a second account of the initiated funds transfer, wherein the second account is the target account for the initiated funds transfer.

13. The method of claim 11, wherein the wirelessly receiving information comprises wirelessly receiving at a second mobile device directly from the first mobile device a digital certificate as an e-check.

14. The method of claim 12, further comprising authenticating at least one of an identity of the first mobile device, that the first mobile device is in possession of a first authorized user, that the first authorized user is an authorized user of the first account, an identity of the second mobile device, that the second mobile device is in possession of a second authorized user, that the second authorized user is an authorized user of the second account or combinations thereof.

15. The method of claim 11, further comprising notifying a second mobile device associated with a second account of the initiated funds transfer, wherein the second account is the target account for the initiated funds transfer, and at least one of the first account and the second account is a pooled account with more than one authorized user.

16. The method of claim 11, further comprising verifying that an established relationship exists with the first account prior to notifying a device associated with a target account for the initiated funds transfer.

17. The method of claim 11, wherein the first mobile device includes voice capabilities as a telephone.

18. The method of claim 17, wherein the first mobile device includes e-mail capabilities over the Internet.

19. The method of claim 11, wherein after a user of a target device for the funds transfer accepts terms regarding the funds transfer at least one of the user and the target device becomes part of a special network less in size than the entire mobile network.

20. A method comprising:
receiving information at a financial institution regarding an initiated funds transfer initiated at a first mobile device regarding an account native at the financial institution; and
authorizing the funds transfer.
